(19) United States
(12) Patent Application Publication
(10) Pub. No.: US 2014/0032241 A1
(43) Pub. Date: Jan. 30, 2014

(54) METHOD, APPARATUS AND COMPUTER PROGRAM PRODUCT FOR MONITORING CLINICAL STATE OF A SUBJECT

(71) Applicant: Rene Coffeng, Helsinki (FI)

(72) Inventor: Rene Coffeng, Helsinki (FI)

(73) Assignee: General Electric Company, Schenectady, WI (US)

(21) Appl. No.: 13/558,845

(22) Filed: Jul. 26, 2012

(51) Int. Cl. G06F 19/00

(52) U.S. Cl. CPC G06F 19/3406
USPC 705/3

(57) ABSTRACT

A method, device, and computer program product for monitoring clinical state of a subject are disclosed. To facilitate the manual adaptation of the care processes to the current state of a patient at least one input parameter is retrieved, wherein each input parameter is indicative of control applied to a respective physiological process of the subject. An output parameter is acquired for each of the at least one input parameter, thereby to obtain a parameter pair, wherein each input and output parameter is indicative of the respective physiological process. Each parameter pair is presented on a dedicated two-dimensional plot comprising a first axis representing respective input parameter and a second axis representing, respective output parameter, wherein the first axis is scaled according to the input operating range of the respective input parameter and the second axis is scaled according to the output operating range of the respective output parameter.

### BACKGROUND OF THE INVENTION

This disclosure relates generally to patient monitoring. More particularly, the present invention relates to devices and systems in which a user controls, based on physiological parameters derived from a subject, the care or treatment applied to the subject. Such a device may be, for example, a ventilator, an anesthetic system, or a patient monitor.

Patient monitors are electronic devices designed to display physiological information about a subject. Electrocardiogram (ECG), electroencephalogram (EEG), plethysmographic signals, and signals related to blood pressure, temperature, and respiration represent typical physiological information contained in full-size patient monitors. Patient monitors are typically also furnished with alarming functionality to alert the nursing staff when a vital sign or physiological parameter of a patient exceeds or drops below a preset limit. Alarms are normally both audible and visual effects aiming to alert the staff to a life-threatening condition or to another event considered vital. In most monitors, the alarm limits may be defined by the user, since the limits typically depend on patient etiology, age, gender, medication, and various other subjective factors. Each specific physiological parameter, such as heart rate or blood pressure, may also be assigned more than one alarm limit.

In addition to individual sensor/parameter alarms, patient monitors can be configured to raise combinatory alarms. That is, several physiological parameters may be used to determine a combined index and to give an alarm when the combined index fulfills a specific criterion. The combinatory alarms may range from simple combinations like “low heart rate and low arterial pressure” to complex rule-based scenarios used in various clinical expert systems. These systems help the medical staff to use standardized guidelines and treatment procedures and support the medical staff in clinical decision-making.

However, due to the complexity of the built-in intelligence of such systems, it may be difficult for a clinician to grasp the connection between an alarm and the underlying physiological behavior of the patient.

Since it is difficult for a caregiver to control a plurality of stand-alone devices and to interpret the information obtained from a plurality of devices, present patient monitoring devices are often integrated devices in which many capabilities are integrated and in which the built-in intelligence helps the caregiver to get an overall picture of the true status of the patient. For example, monitoring devices used in operating theatres are often provided with ventilation and drug delivery facilities, so that a single monitoring device may offer integration through the entire treatment period.

Due to the integration, these devices are provided with an increasing amount of user-adjustable control parameters, such as ventilation and drug therapy control parameters, to adapt the care processes to the current status of the patient concerned. The care processes are during the course of treatment continuously optimized to give the patient as safe and high quality therapy as possible.

However, the devices are not fully automated closed loop control devices, but user action is needed in response to an alarm event or to a change in the state of the subject. That is, the user acts as a link between the measurement devices that measure the physiological parameters and the devices through which the care is provided. A problem related to these systems is the manual adaptation of the care processes to the current situation, especially in challenging situations and environments, such as operating rooms and intensive care units, where the number of physiological parameters to be monitored continuously and simultaneously is rather high. The adaptation problem is further aggravated by the fact that the amount of closely related parameters is increasing, which makes the cognitive task of the clinicians even more demanding. Consequently, clinicians have problems in making the correct settings in response to an alarm or a change in the state of the subject. Currently, clinicians typically look at trend histories and scroll through device pages to find interdependencies of trends and to recognize causes for the changes.

One reason for the above adaptation problem is that current devices and systems are not able to provide information that would facilitate the manual adaptation. That is, the current way of indicating the state of the subject by a collection of various, often interrelated parameters does not facilitate the cognitive task of the clinicians of deciding on how to adapt the care process and the device settings to the changes in the state of the subject.

### BRIEF DESCRIPTION OF THE INVENTION

The above-mentioned problem is addressed herein which will be comprehended from the following specification. In the solution disclosed, a parameter pair whose two parameters are interrelated by a physiological process or body function is presented on a two-dimensional plot, thereby to illustrate the correlation between the control settings of the care process and the physiological parameters measured from the subject. One or more parameter pairs may be presented on a corresponding number of two-dimensional plots.

In an embodiment, a method for monitoring clinical state of a subject comprises retrieving at least one input parameter, wherein each input parameter is indicative of control applied to a respective physiological process of the subject, and acquiring an output parameter for each of the at least one input parameter, thereby to obtain at least one parameter pair comprising an input parameter and an output parameter, wherein each output parameter is indicative of respective physiological process and depends on respective input parameter through respective physiological process. The method further includes attaching an input operating range to each input parameter and an output operating range to each output parameter, thereby to obtain at least one input operating range and at least one output operating range, and presenting each parameter pair on a dedicated two-dimensional plot comprising a first axis representing respective input parameter and a second axis representing respective output parameter, wherein the first axis is scaled according to the input operating range of the respective input parameter and the second axis is scaled according to the output operating range of the respective output parameter.

In another embodiment, an apparatus for monitoring clinical state of a subject comprises an input parameter unit adapted to retrieve at least one input parameter, wherein each input parameter is indicative of control applied to a respective physiological process of the subject, and an output parameter unit adapted to acquire an output parameter for each of the at least one input parameter, thereby to obtain at least one parameter pair comprising an input parameter and an output parameter, wherein each output parameter is indicative of respective physiological process and depends on respective input parameter through respective physiological process. The apparatus further includes a plot generation unit configured to attach an input operating range to each input parameter and an output operating range to each output parameter, thereby to obtain at least one input operating range and at least one output operating range, and a presentation unit adapted to present each parameter pair on a dedicated two-dimensional plot comprising a first axis representing respective input parameter and a second axis representing respective output parameter, wherein the first axis is scaled according to the input operating range of the respective input parameter and the second axis is scaled according to the output operating range of the respective output parameter.

In a still further embodiment, a computer program product for monitoring clinical state of a subject comprises a first program product portion configured to retrieve at least one input parameter, wherein each input parameter is indicative of control applied to a respective physiological process of the subject and a second program product portion configured to acquire an output parameter for each of the at least one input parameter, thereby to obtain at least one parameter pair comprising an input parameter and an output parameter, wherein each output parameter is indicative of respective physiological process and depends on respective input parameter through respective physiological process. The computer program product further comprises a third program product portion configured to attach an input operating range to each input parameter and an output operating range to each output parameter, and a fourth program product portion configured to present each parameter pair on a dedicated two-dimensional plot comprising a first axis representing respective input parameter and a second axis representing respective output parameter, wherein the first axis is scaled according to the input operating range of the respective input parameter and the second axis is scaled according to the output operating range of the respective output parameter.

Various other features, objects, and advantages of the invention will be made apparent to those skilled in the art from the following detailed description and accompanying drawings.

### BRIEF DESCRIPTION OF THE DRAWINGS

FIG. 1 illustrates one embodiment of an apparatus or system for monitoring a subject;

FIG. 2 illustrates a parameter pair employed for monitoring a subject;

FIG. 3 is a flow diagram illustrating one embodiment of the operation of the control and processing unit of FIG. 1 for presenting the state of a subject through a set of parameter pairs;

FIG. 4 illustrates an example of a parameter pair view displayed to a user; and

FIG. 5 illustrates the operational entities of the control and processing unit of FIG. 1 in terms of the generation of the parameter pair view.

### DETAILED DESCRIPTION OF THE INVENTION

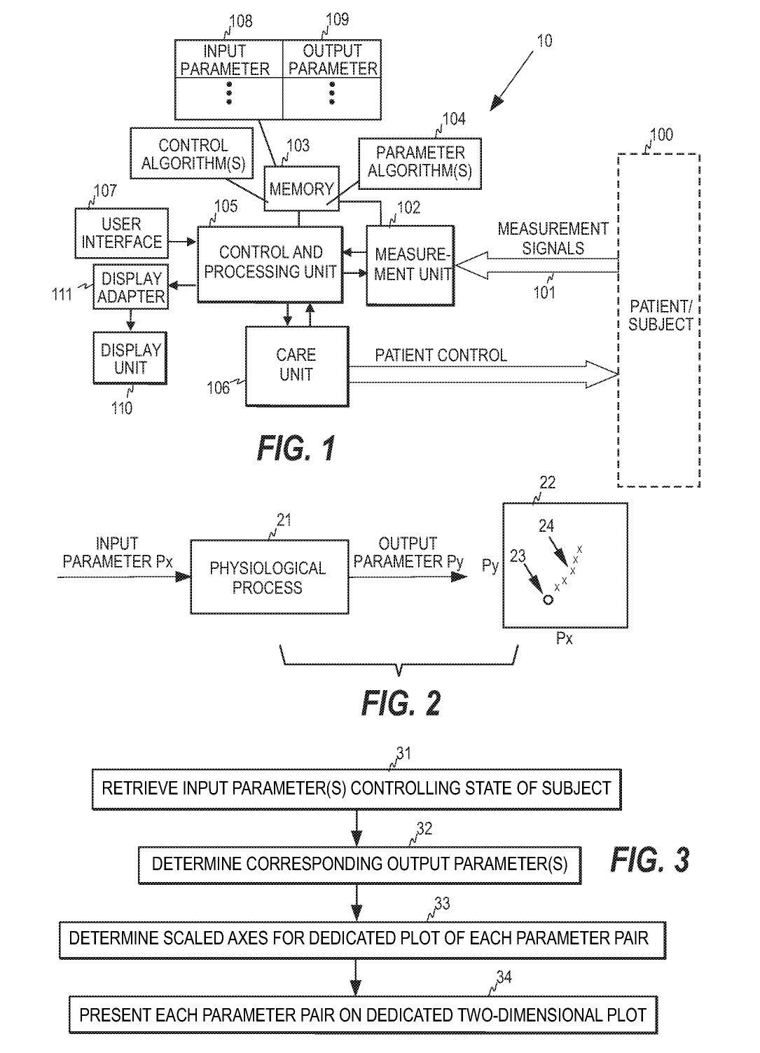

FIG. 1 schematically illustrates one embodiment of an apparatus or a system 10 for providing care to a subject 100 and for monitoring the clinical state of the subject. The system/apparatus may be, for example, a patient monitor, an anesthesia system and/or a ventilator system. The state of the subject may thus be monitored in a variety of different medical systems, devices or environments.

Such a system or apparatus normally acquires a plurality of physiological signals 101 from the subject, where one physiological signal corresponds to one measurement channel. The physiological signals typically comprise several types of signals, such as ECG, EEG, blood pressure, respiration, and plethysmographic signals. Based on the raw real-time physiological signal data obtained from the subject, a plurality of physiological parameters may be determined. A physiological parameter here refers to a variable calculated from the waveform data of one or more of the physiological signals acquired from the subject. If a physiological parameter is derived from more than one physiological signal, i.e. from more than one measurement channel, the said physiological signals are usually of the same signal type. The physiological parameter may thus also represent a waveform signal value determined over a predefined period of time, although the physiological parameter is typically a distinct parameter derived from one or more measurement channels, such as heart rate derived from an ECG signal or an SpO2 value derived from a plethysmographic signal. Each physiological parameter may be assigned one or more alarm limits to alert the nursing staff when the parameter reaches or crosses the alarm limit.

The physiological signals acquired from the subject 100 may be supplied to a separate measurement unit 102 through a pre-processing stage (not shown) comprising typically an input amplifier and a filter, for example. The measurement unit converts the signals into digitized format for each measurement channel. The digitized signal data may then be stored in a memory 103 of the system. To determine the physiological parameters, the measurement unit may execute parameter algorithms 104 adapted to record the time series of the parameters. The obtained time series of the parameters may be stored in the memory and/or supplied to a control and processing unit 105 of the system.

The control and processing unit is further adapted to control a care unit/device 106 that provides care to the subject. The care device may be, for example, a mechanical ventilator that generates a controlled flow of gas in its inhalation system (not shown) and supplies the gas flow into the airways of the subject. In this case, the control and processing unit 105 may be configured to adapt the pressure and flow characteristics to the needs of the subject, which may be defined by the user through a user interface 107 of the ventilator system.

It is also possible that the parameter time series are determined in the control and processing unit, i.e. that the system does not include a separate measurement unit.

For monitoring the state of the subject, the control and processing unit is configured to produce one or more input-output parameter pairs. In each pair, the input parameter is indicative of the control applied to a given physiological process of the subject through the care unit 106, while the output parameter is a physiological parameter that depends on the same physiological process. Consequently, the input and output parameters are interrelated by the physiological process. FIG. 2 illustrates one input-output parameter pair Px/Py. The input parameter Px controls a given physiological process 21, while the respective output parameter Py measured from the subject depends on the same physiological process and thus also on the value of the input parameter. The physiological process may involve any activity or function of the human body, which may be controlled by an input parameter and evaluated by an output parameter. The process may be closely related to a certain organ or a body system, and the process may also relate to a certain care phase, such as weaning from a mechanical ventilator. FIG. 2 further shows a two-dimensional plot 22 which is generated onto the screen of the display unit. In the plot, one axis is scaled according to the operating range of the input parameter, while the other axis is scaled according to the operating range of the output parameter. The data point that corresponds to the current values of the input and output parameters is displayed on the plot. In the figure, this data point is denoted with a small dot/circle 23. In addition to the current data point, preceding values of the parameter pair time series may be displayed, as is shown with small crosses 24 in the figure. The plot axis that corresponds to the input parameter typically covers the normal control range of the input parameter, while the plot axis that corresponds to the output parameter typically covers a range from a low alarm limit to a high alarm limit of the output parameter. The plot may be shown as a box, so that it is easy to notice if the parameters are within their respective operating ranges.

With reference to FIG. 1 again, the control and processing unit 105 is adapted to manage the input-output parameter pairs so that each parameter that is used to control a physiological process is linked to an output parameter which depends on the physiological process and which is derived from the physiological data by the measurement unit or the control and processing unit. The input and output parameters, 108 respectively 109, may be stored in the memory 103 of the system. The control and processing unit is further adapted to control a display unit 110 through a display adapter 111, thereby to present each input-output parameter pair on a dedicated two-dimensional plot on the screen of the display unit.

FIG. 3 illustrates an embodiment of the steps carried out by the control and processing unit in view of visualization of the state of the subject. The control and processing unit retrieves at step 31 one or more input parameters that determine the control currently applied to the subject. These input parameters are typically set by the user of the device/system and therefore the control and processing unit only needs to retrieve the current values of the parameter(s). However, the user may also select the input parameter(s) to be retrieved in step 31. The input parameter(s) may control one or more physiological processes and more than one input parameter may control the same physiological process, such as breathing/respiration. The control and processing unit then determines the output parameter(s) that correspond(s) to each input parameter, thereby to obtain at least one input-output parameter pair (step 32). The determination may be carried out by retrieving one or more parameters determined by the measurement unit or by deriving the parameter(s) from the physiological signals obtained from the subject. The control and processing unit further determines (step 33) scaled axes for the dedicated two-dimensional plot of each input-output parameter pair so that the operating range of one parameter defines the scaling of one axis while the operating range of the other parameter defines the scaling of the other axis. The operating range may be defined according to the normal values of the parameter. For example, in the above box 22 the low end of the output parameter axis may correspond to the low alarm limit of the respective output parameter and the high end to the high alarm limit of the respective parameter. To give an example, the axis of heart rate could extend from 40 to 120 (beats per minute). The input parameter axis in turn typically covers the normal control range of the parameter. For example, the control range of the volume of inhaled gas may extend from 2 to 8 litres per minute.

Finally, the control and processing unit presents each parameter pair on the plot of that pair (step 34). As indicated above, preceding data points of the time series may also be presented. The color of the dot may depend on the location of the data point. For example, different colors may used for data points located within and outside the box.

The above monitoring mechanism makes it easy for the user to notice which parameters are not within their normal range. The human eye is very sensitive to noticing this kind of irregularities, i.e. a dot missing from a box. Further, it is easy to grasp the relation of a key parameter to the control applied to the subject and also the relation to the other key parameters that may be out of their normal range.

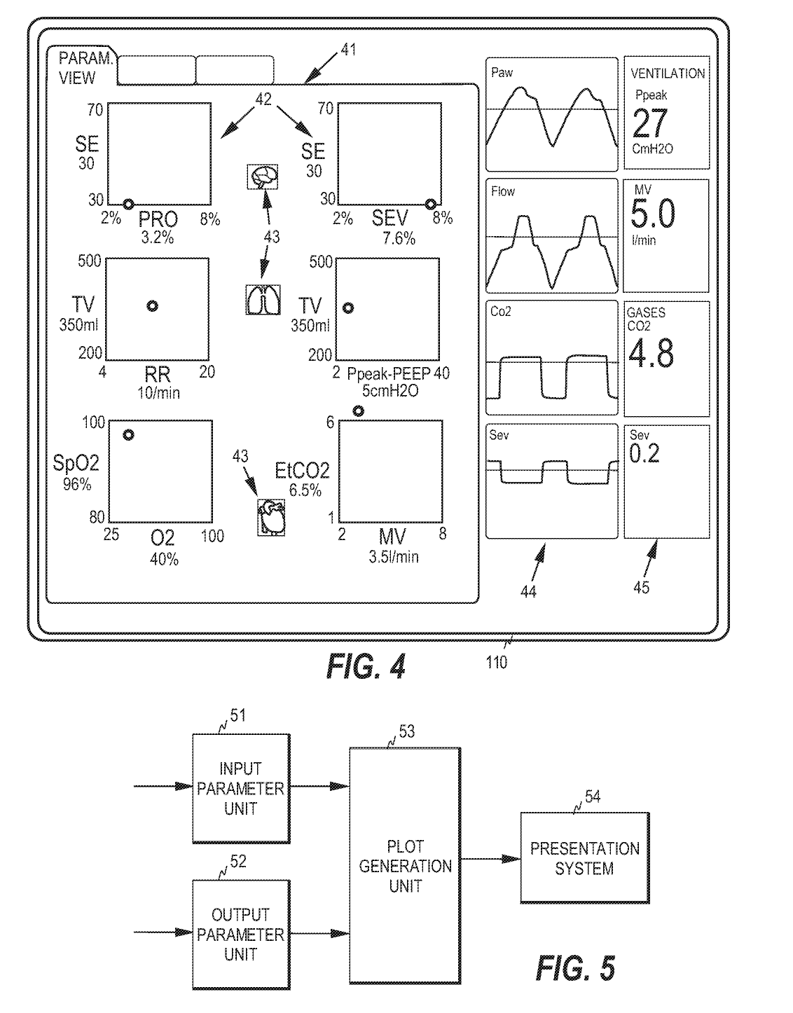

FIG. 4 illustrates an example of a screen page 41 displayed to the user in step 34. The screen page comprises in this example six two-dimensional plots 42 for the following input-output parameter pairs: propofol concentration (PRO)—entropy (SE), sevoflurane concentration (SEV)—entropy (SE), respiration rate (RR)—tidal volume (TV), median inflation pressure (equals peak pressure, Ppeak, minus positive end-expiratory pressure, PEEP)—tidal volume (TV), fraction of inspired oxygen (O2)—oxygen saturation (SpO2), and minute volume (MV)—end-tidal breath CO2 (EtCO2). Each plot is in the form of a square box in which the horizontal side is scaled according to the operating range of the respective input parameter and vertical side according to the operating range of the respective output parameter. Each plot shows a dot or circle whose location on the plot corresponds to the current values of the respective input and output parameter. In this example, three of the six data points are within the respective box, two at the edge of the respective box, and one outside the respective box. The limit values of the box and the current values of the parameters may also be presented, as is illustrated in the figure.

In an embodiment, the parameter pairs may be grouped according to the physiological process involved. In the example of FIG. 4, group-specific symbols 43 are displayed to indicate the physiological process concerned: the first two parameter pairs, PRO—SE and SEV—SE, relate to cerebral functions (anesthetic state), the next two parameter pairs RR—TV and (Ppeak-PEEP)—TV relate to the respiratory system, and the last two parameter pairs O2—SpO2 and MV—EtCO2 relate to cardiovascular functions.

In addition to the screen page including the input-output parameter plots, the same screen view may include various other elements and information, such as windows 44 that include related waveforms and windows 45 that include related numerical data.

In terms of the monitoring the clinical state of the subject through the input-output parameter pairs, the control and processing unit of FIG. 1 may thus be seen as an entity of three operational modules or units, as is illustrated in FIG. 5. An input parameter unit 51 is configured to acquire the current value of each input parameter, an output parameter unit 52 is configured to acquire the current values of the output parameters that correspond to the input parameters, and a plot generation unit 53 is configured to produce the parameter pairs and the corresponding two-dimensional plots. The plot generation unit supplies data to a display system 54, thereby to visualize the clinical state of the subject to the user by displaying the plots provided with the data points. The display system may include multiple display units.

A conventional system or apparatus may also be upgraded to enable the system to visualize the state of the subject in the above manner. Such an upgrade may be implemented, for example, by delivering to the system a software module that may involve different functionality depending on the parameters available in the system. The software module may be delivered, for example, on a data carrier, such as a CD or a memory card, or the through a telecommunications network. Since the software module may utilize the physiological parameters already determined by the system/monitor, the module does not necessarily comprise more than the portions needed to generate and display the parameter pairs.

The apparatus or system may also be a mere monitoring device, such as review station at a remote location. For example, a doctor may examine the screen page in an office to advice the nursing staff on how to adjust the input parameters to keep the parameter values substantially in the middle of the boxes. The apparatus may also be implemented as an auxiliary apparatus or display unit connectable to an existing system that collects physiological data from a subject. In this embodiment, the apparatus/unit may comprise the functionality of the software module, for example.

In the above monitoring mechanism, the output parameters that are measured from the subject to determine the state of the subject are not anymore distinct parameters related to certain measurement sensors, but rather parameters related to the current control settings of certain physiological processes. Moreover, the plots are scaled according to the operating ranges of the respective parameters and several key plots may be displayed in one screen window, which may also show how the output parameter responds to the control over time. Due to these characteristics, the above monitoring mechanism enables the user to quickly comprehend the correlations between the control and the output parameters that define the state of the subject. Further, the plots help the user to notice if any of the physiological processes of the subject is not well under control and to make a decision on how to adjust the control settings to return to normal state.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural or operational elements that do not differ from the literal language of the claims, or if they have structural or operational elements with insubstantial differences from the literal language of the claims.

1. A method for monitoring clinical state of a subject, the method comprising:
retrieving at least one input parameter, wherein each input parameter is indicative of control applied to a respective physiological process of the subject;
acquiring an output parameter for each of the at least one input parameter, thereby to obtain at least one parameter pair comprising an input parameter and an output parameter, wherein each output parameter is indicative of respective physiological process and depends on respective input parameter through respective physiological process;
attaching an input operating range to each input parameter and an output operating range to each output parameter, thereby to obtain at least one input operating range and at least one output operating range;
presenting each parameter pair on a dedicated two-dimensional plot comprising a first axis representing respective input parameter and a second axis representing respective output parameter, wherein the first axis is scaled according to the input operating range of the respective input parameter and the second axis is scaled according to the output operating range of the respective output parameter.

2. The method according to claim 1, wherein the acquiring comprises retrieving each output parameter from a predetermined memory location.

3. The method according to claim 1, wherein the acquiring comprises deriving each output parameter from physiological signal data obtained from the subject.

4. The method according to claim 1, wherein the attaching comprises attaching the input operating range to each input parameter and the output operating range to each output parameter, in which at least one of the at least one output operating range extends from a low alarm limit to a high alarm limit of respective output parameter.

5. The method according to claim 1, wherein the attaching comprises attaching the input operating range to each input parameter and the output operating range to each output parameter, in which at least one of the at least one input operating range covers a normal control range of a respective input parameter.

6. The method according to claim 1, wherein the presenting each parameter pair comprises presenting a plurality of two-dimensional plots on a screen of a display unit.

7. The method according to claim 6, further comprising
dividing the plurality of two-dimensional plots into multiple groups so that each group is associated with a respective physiological process; and
providing each group with a dedicated symbol indicative of the physiological process associated with the group.

8. The method according to claim 1, wherein the presenting further includes presenting successive values of each parameter pair on respective two-dimensional plot.

9. An apparatus for monitoring clinical state of a subject, the apparatus comprising:
an input parameter unit adapted to retrieve at least one input parameter, wherein each input parameter is indicative of control applied to a respective physiological process of the subject;
an output parameter unit adapted to acquire an output parameter for each of the at least one input parameter, thereby to obtain at least one parameter pair comprising an input parameter and an output parameter, wherein each output parameter is indicative of respective physiological process and depends on respective input parameter through respective physiological process;
a plot generation unit configured to attach an input operating range to each input parameter and an output operating range to each output parameter, thereby to obtain at least one input operating range and at least one output operating range; and
a presentation unit adapted to present each parameter pair on a dedicated two-dimensional plot comprising a first axis representing respective input parameter and a second axis representing respective output parameter, wherein the first axis is scaled according to the input operating range of the respective input parameter and the second axis is scaled according to the output operating range of the respective output parameter.

10. The apparatus according to claim 9, wherein the output parameter unit is configured to retrieve each output parameter from a predetermined memory location.

11. The apparatus according to claim 9, wherein the output parameter unit is configured to derive each output parameter from physiological signal data obtained from the subject.

12. The apparatus according to claim 9, wherein at least one of the at least one output operating range extends from a low alarm limit to a high alarm limit of respective output parameter.

13. The apparatus according to claim 9, wherein at least one of the at least one input operating range covers a normal control range of a respective input parameter.

14. The apparatus according to claim 9, wherein the presentation unit is adapted to present a plurality of two-dimensional plots on a screen of a display unit.

15. The apparatus according to claim 14, wherein the presentation unit is further adapted to
divide the plurality of two-dimensional plots into multiple groups so that each group is associated with a given physiological process; and
provide each group with a dedicated symbol indicative of the physiological process associated with the group.

16. The apparatus according to claim 9, wherein the presentation unit is further adapted to present successive values of each parameter pair on respective two-dimensional plot.

17. A computer program product for monitoring clinical state of a subject, the computer program product comprising:
a first program product portion configured to retrieve at least one input parameter, wherein each input parameter is indicative of control applied to a respective physiological process of the subject;
a second program product portion configured to acquire an output parameter for each of the at least one input parameter, thereby to obtain at least one parameter pair comprising an input parameter and an output parameter, wherein each output parameter is indicative of respective physiological process and depends on respective input parameter through respective physiological process;
a third program product portion configured to attach an input operating range to each input parameter and an output operating range to each output parameter; and
a fourth program product portion configured to present each parameter pair on a dedicated two-dimensional plot comprising a first axis representing respective input parameter and a second axis representing respective output parameter, wherein the first axis is scaled according to the input operating range of the respective input parameter and the second axis is scaled according to the output operating range of the respective output parameter.

18. The computer program product according to claim 17, wherein the second program product portion is configured to retrieve each output parameter from a predetermined memory location.

19. The computer program product according to claim 17, wherein the second program product portion is configured to derive each output parameter from physiological signal data obtained from the subject.
